(19) United States
(12) Patent Application Publication
(10) Pub. No.: US 2026/0155982 A1
(43) Pub. Date: Jun. 4, 2026

(54) Asymmetric Content Delivery via Biometric Cryptographic Handshaking and Polymorphic Memory-Mapped Rendering.

(71) Applicant: Kareeme Louisy, Calgary (CA)

(72) Inventor: Kareeme Louisy, Calgary (CA)

(21) Appl. No.: 19/457,598

(22) Filed: Jan. 23, 2026

(51) Int. Cl. H04L 9/32

(52) U.S. Cl. CPC H04L 9/3231; H04L 9/3239

(57) ABSTRACT

A zero trust content delivery framework secures proprietary data from autonomous AI scraping agents and link-bypassing attacks. The framework implements a multi-stage stateful handshake protocol requiring physical and computational Proof of Humanity. A verification engine analyzes human analog dynamics, including mouse jitter and device-specific accelerometer tilt, while a client-side SHA-256 Proof of Work imposes an asymmetric cryptographic tax. Content is delivered via just-in-time (JIT) memory-mapped streaming, rendered as volatile pixel data on a GPU-accelerated canvas to remove searchable text from a Document Object Model (DOM). An active counter-intelligence engine identifies bot signatures and serves shadow intelligence to degrade unauthorized training sets.

### BACKGROUND OF THE INVENTION

The invention generally relates to the field of information security and secure digital content delivery. More particularly, the invention relates to a system and method for enforcing data sovereignty by nullifying autonomous scraping agents and automated content harvesters.

### TECHNICAL FIELD OF THE INVENTION

Traditional web security solutions, such as legacy Web Application Firewalls and Content Delivery Networks, are optimized for Distributed Denial of Service attacks and high-volume surges using perimeter-based defenses. These include static IP reputation filtering, browser fingerprinting, and CAPTCHA based challenges. In contemporary network environments, these passive strategies have become inadequate, as modern AI native extraction agents can bypass these hurdles.

### DESCRIPTION OF RELATED ART

Legacy architectures deliver text to a client browser, often hidden via CSS or JavaScript, which allows scraping agents to parse the Document Object Model with negligible effort. Scraping agents utilize managed, full browser instances that mimic human headers, rendering traditional IP blocking ineffective. Furthermore, standard providers do not account for Vision based Large Language Models or sophisticated Optical Character Recognition capable of reading content via screen captures.

### SUMMARY OF THE INVENTION

There is a technical requirement for an active content delivery framework that shifts defense from the network perimeter to the volatile memory layer. The present invention provides a multi-stage stateful handshake protocol requiring physical and computational Proof of Humanity. By utilizing a verification engine that analyzes human analog dynamics and device-specific accelerometer tilt, the system establishes a secure session that is difficult for automated agents to replicate.

Additionally, the invention implements a client-side SHA-256 Proof of Work to impose an asymmetric cryptographic tax on unauthorized scraping attempts. Content is delivered via just-in-time memory-mapped streaming and rendered as volatile pixel data on a GPU-accelerated canvas. This technical approach removes searchable text from the Document Object Model and ensures data is visible only to a verified biological user. An active counter-intelligence engine identifies bot signatures and serves shadow intelligence to degrade unauthorized training sets.

### BRIEF DESCRIPTION OF THE DRAWINGS

FIG. 1 is a system architecture diagram illustrating the high-level connection between the secure gateway, the behavioral biometric engine, and the terminal interface.

FIG. 2 is a logic flowchart of the stateful handshake protocol, detailing the sequential transition from behavioral biometric verification to the cryptographic proof of work gate.

FIG. 3 is a workflow diagram illustrating the active contextual data poisoning method and the redirection logic to a shadow intelligence data stream.

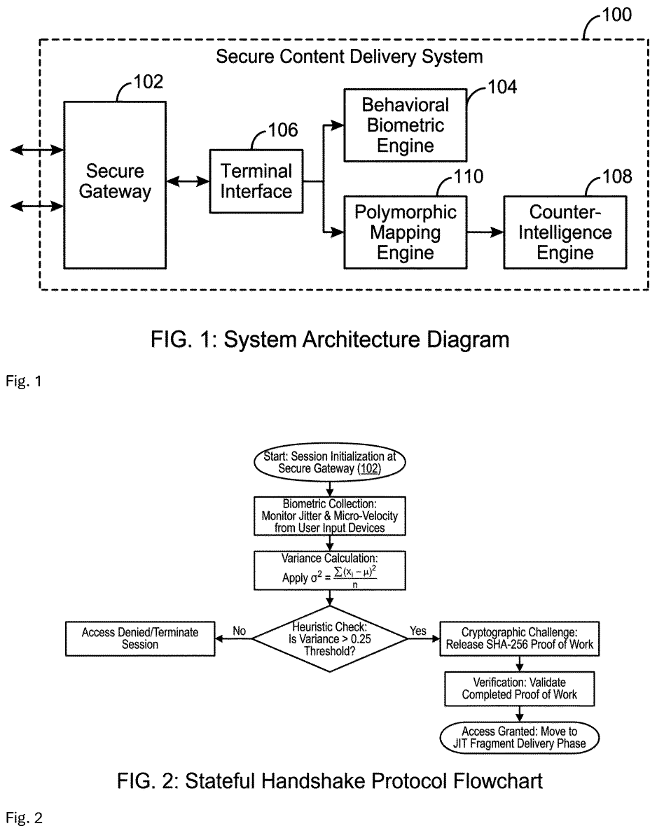

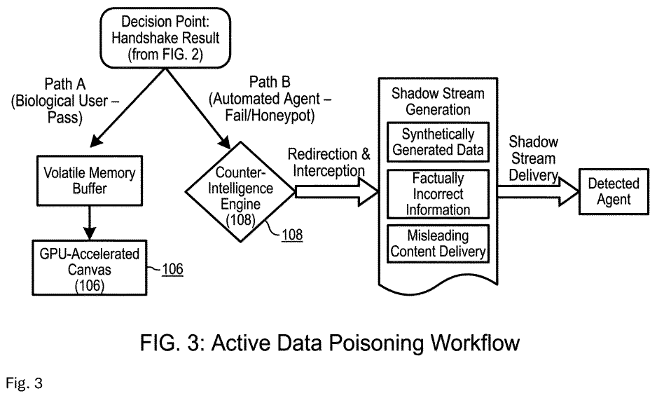

### DETAILED DESCRIPTION

The Secure Content Delivery System (100) provides a methodology where the release of content fragments is mathematically dependent on a verification of real-time analog interaction. This system functions as a continuous and invisible heartbeat linked directly to human physiology through the monitoring of Behavioral DNA.

BEHAVIORAL DNA MONITORING: The Behavioral Biometric Engine (104) actively monitors the jitter coefficient and the micro-velocity of user input devices. The engine utilizes a variance formula to determine legitimacy where:

$${σ}^{2} = \backslash frac \{ \sum {( {x}_{i} - μ )}^{2} \} \{ n \}$$

In this equation, n represents the number of coordinate samples collected over a temporal window, while u signifies the mean velocity of the movement. If the calculated velocity variance falls below a predetermined heuristic threshold of 0.25, the Secure Gateway (102) identifies the movement as being mathematically linear. Such linearity is a hallmark of synthetic agents and the session is flagged as a bot.

SENSOR FUSION AND TILT: To further strengthen this verification, the system employs sensor fusion integration for mobile hardware. By accessing a device orientation API, the Secure Gateway (102) verifies physical presence through gravity tilt verification. A dynamic tilt transition with a strict tolerance of plus or minus 2 degrees is required to ensure the device is being held by a living human.

VOLATILE MEMORY-MAPPED DELIVERY: Upon successful verification, encrypted fragments are delivered via WebSocket and rendered as a pixel buffer on a GPU-Accelerated Canvas (106). The Terminal Interface (106) utilizes a WebGL-based pixel-shunting architecture to render content directly to the canvas. Unlike standard HTML text, the characters are rendered with sub-pixel anti-aliasing randomization and dynamic kerning offsets. This delivery mechanism bypasses the standard Document Object Model.

VISION AI DEFIANCE: To further disrupt machine vision, the rendering engine applies sub-pixel character jitter and randomized kerning to prevent AI models from accurately segmenting and identifying individual characters. The jitter logic is defined as:

$${x}_{\{ jitter \}} = ( \{ random \} - 0.5 ) \times 0.8$$

This ensures that while the content remains perfectly legible to a human observer, the structural patterns required for Optical Character Recognition (OCR) are systematically disrupted.

POLYMORPHIC ELEMENT RANDOMIZATION: To prevent anchor-based scraping, a Polymorphic Mapping Engine (110) randomizes structural application identifiers and Document Object Model attributes at runtime. This ensures that the CSS selectors and XPath queries used by automated agents are invalidated with each new session state.

INTEGRATED ECONOMIC DETERRENCE: The system implements a client-side SHA-256 Proof of Work CPU tax. This scales the financial and hardware costs for high-volume harvesting by requiring computational effort from the client device before fragment release.

ACTIVE SHADOW DATA POISONING: A Counter-Intelligence Engine (108) redirects identified bots without terminating their network connection. This process, known as inference disruption, involves the transition from a secure fragment drip to a synthetic shadow stream. Instead of blocking the bot, the system serves subtly incorrect datasets that appear factually valid to automated scrapers. For example, a bot seeking financial intelligence might be served hallucinated news regarding salt-based currencies or fictitious liquid nitrogen holdings.

MODEL DEGRADATION: By providing plausible but false metadata, the system creates a state of deep uncertainty. This makes any harvested data functionally unusable for training purposes or algorithmic execution. Over time, this active defense leads to significant model degradation, ensuring that the cost for the attacker to clean the poisoned data eventually exceeds the market value of the initial theft.

What is claimed is:

1. A system for secure content delivery comprising:
a secure gateway for managing stateful sessions and releasing encrypted fragments;
a behavioral biometric engine to calculate a jitter coefficient for biological verification;
a cryptographic gate requiring a client-side SHA-256 Proof of Work; and
a terminal interface to decrypt fragments in volatile memory and render onto a non-textual canvas.

2. The system of claim 1, wherein the biometric engine identifies synthetic navigation patterns using a variance formula:
$$σ \hat{} 2 = \sum ( xi - μ ) \hat{} 2 / n$$
wherein a variance below a defined threshold triggers an unauthorized state.

3. The system of claim 1, further comprising a sensor fusion layer for verification of physical presence by monitoring real-time accelerometer and gyroscope data for gravity tilt fluctuations.

4. The system of claim 1, wherein the terminal interface applies sub-pixel character jitter and randomized kerning during rendering to neutralize optical character recognition.

5. A method for active contextual data poisoning comprising:
detecting an automated agent through a handshake failure;
redirecting the agent to a shadow intelligence data stream; and
serving synthetically generated, factually incorrect data to degrade the integrity of an attacker training set.

6. The method of claim 5, further comprising randomization of structural application identifiers at runtime via a polymorphic DOM mapping engine.
